(19) United States
(12) Patent Application Publication
(10) Pub. No.: US 2026/0021751 A1
(43) Pub. Date: Jan. 22, 2026

(54) SEAT MEMBER MOVABLE DEVICE

(71) Applicant: TOYOTA BOSHOKU KABUSHIKI KAISHA, Aichi-ken (JP)

(72) Inventor: Tadasuke HIGUCHI, Aichi-ken (JP)

(73) Assignee: TOYOTA BOSHOKU KABUSHIKI KAISHA, Aichi-ken (JP)

(21) Appl. No.: 19/264,320

(22) Filed: Jul. 9, 2025

(30) Foreign Application Priority Data
Jul. 16, 2024 (JP) 2024-113318

(51) Int. Cl. B60N 2/14; B60N 2/02

(52) U.S. Cl. CPC B60N 2/146; B60N 2/02253

(57) ABSTRACT

A seat member movable device that moves a seat member with respect to a placement base, the seat member movable device including a support disc that supports the seat member, a base that supports the support disc so as to be movable with respect to the placement base, and a drive device that moves the support disc. In a restrained state in which movement of the support disc is restrained by a restraining unit, as a lifting/lowering shaft is rotated by driving of a motor, a pinion moves in a first direction, and moves one of a first plate-shaped member and a second plate-shaped member in a direction away from the other thereof, to release the restrained state by the restraining unit.

### CROSS REFERENCE TO RELATED APPLICATIONS

This nonprovisional application is based on Japanese Patent Application No. 2024-113318 filed on Jul. 16, 2024 with the Japan Patent Office, the entire contents of which are hereby incorporated by reference.

### BACKGROUND OF THE INVENTION

### Field of the Invention

The present disclosure relates to a seat member movable device.

### Description of the Background Art

For example, Chinese Utility Model No. 215921965 discloses a seat member movable device that transmits a side impact load of a vehicle to a structural member of the seat member movable device in order to protect a battery from the side impact load of the vehicle.

The seat member movable device according to Chinese Utility Model No. 215921965 includes a fixing member, a rotary member, a locking mechanism, an unlocking motor, a drive mechanism, and a drive motor. The rotary member is rotatably supported by the fixing member. The rotary member is fixed to the fixing member by the locking mechanism.

When the rotary member is rotated, firstly, the unlocking motor releases the fixed state of the rotary member by the locking mechanism. Secondly, the drive motor rotates the rotary member via the drive mechanism. Thirdly, the unlocking motor fixes the rotary member by the locking mechanism.

Since the seat member rotating device having such a configuration includes two motors, coordination in controlling the motors is required, which leads to a complicated structure, as well as an increase in the number of components and an increase in weight.

### SUMMARY OF THE INVENTION

The present disclosure has been made to solve the aforementioned problem, and an object thereof is to provide a seat member movable device having a smaller number of components and a lighter weight than a conventional seat member movable device.

A seat member movable device according to a first aspect of the present disclosure is a seat member movable device that moves a seat member with respect to a placement base, the member movable device including a support disc that supports the seat member, a base that supports the support disc so as to be movable with respect to the placement base, and a drive device that moves the support disc. The drive device includes a drive unit and a restraining unit. The drive unit has a motor, a pinion formed to move the support disc, and a lifting/lowering shaft. The lifting/lowering shaft is formed to extend in a first direction, and is formed to be rotatable by driving of the motor. Further, the lifting/lowering shaft has a support portion in which a spiral groove is formed. An insertion hole into which the lifting/lowering shaft is inserted is formed at a center of the pinion, and on an inner circumferential surface defining the insertion hole, a guide corresponding to the spiral groove formed in the support portion is formed. The restraining unit has a movable portion and a restraining portion. The movable portion has a first plate-shaped member, a second plate-shaped member, a spring, and an interlocking gear. The first plate-shaped member and the second plate-shaped member are arranged in the first direction with the pinion being sandwiched therebetween. The spring connects the first plate-shaped member and the second plate-shaped member, and applies a force that brings the first plate-shaped member closer to the second plate-shaped member, to the first plate-shaped member and the second plate-shaped member. The interlocking gear connects the first plate-shaped member and the second plate-shaped member, and is formed to transmit movement of one of the first plate-shaped member and the second plate-shaped member closer to or away from another thereof, to the other thereof. The restraining portion is formed to restrain movement of the support disc. In a restrained state in which the movement of the support disc is restrained by the restraining unit, as the lifting/lowering shaft is rotated by the driving of the motor, the pinion moves in the first direction, and moves the one of the first plate-shaped member and the second plate-shaped member in a direction away from the other thereof, to release the restrained state by the restraining unit.

In the seat member movable device according to the first aspect of the present disclosure, the first plate-shaped member has a first plate portion, and the second plate-shaped member has a second plate portion. The restraining portion may have a first gripping portion and a second gripping portion. The first gripping portion may have one end formed to be connected to the first plate portion, and another end formed to extend toward the support disc in a second direction intersecting the first direction. The second gripping portion may have one end formed to be connected to the second plate portion, and another end formed to extend toward the support disc in the second direction. In the restraining portion, in the restrained state, the first gripping portion and the second gripping portion may sandwich the support disc therebetween.

In the seat member movable device according to the first aspect of the present disclosure, the support disc may have a main body portion, a first contact portion, and a second contact portion. The first contact portion and the second contact portion may be arranged in the first direction, and may be provided on the main body portion. The first contact portion may be formed to protrude in the first direction with respect to an inner circumferential edge portion of the main body portion and a vicinity thereof. The first gripping portion may have a first restraining surface disposed at a surface facing the first contact portion in the first direction. The first restraining surface may be formed to be away from the support disc in the first direction, along a direction from the first plate portion toward the first contact portion. The second contact portion may be formed to protrude in the first direction with respect to the inner circumferential edge portion of the main body portion and the vicinity thereof. The second gripping portion may have a second restraining surface disposed at a surface facing the second contact portion in the first direction. The second restraining surface may be formed to be away from the support disc in the first direction, along a direction from the second plate portion toward the second contact portion.

In the seat member movable device according to the first aspect of the present disclosure, a chamfer surface may be formed on the support disc. The restraining portion has a restraining gear. The restraining gear may be disposed between the first plate-shaped member and the second plate-shaped member, and may be formed to be movable in the first direction as the first plate-shaped member moves. The restraining gear has a gear portion and an abutting portion. The gear portion may be formed to extend in the first direction, and may be formed to be rotatable in a direction opposite to a rotational direction of the pinion, in conjunction with the pinion. The abutting portion may be connected to one end of the gear portion in the first direction. The abutting portion has an abutting surface facing the chamfer surface. In the restraining portion, in the restrained state, the abutting surface may abut against the chamfer surface.

In the seat member movable device according to the first aspect of the present disclosure, the support disc may be formed in an annular shape. An inner diameter of the support disc may be larger than a width of the support disc, which is a difference between an outer diameter and the inner diameter of the support disc. The drive device may be located inside the support disc.

In the seat member movable device according to the first aspect of the present disclosure, the support disc may be formed in an annular shape. An inner diameter of the support disc may be smaller than a width of the support disc, which is a difference between an outer diameter and the inner diameter of the support disc.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a schematic view of a rotary seat according to the present embodiment.

FIG. 2 is a perspective view of a seat rotating device according to the present embodiment.

FIG. 3 is an exploded perspective view of the seat rotating device according to the present embodiment.

FIG. 4 is an enlarged perspective view of a drive device according to the present embodiment.

FIG. 5 is an end view of a cross section along V-V in FIG. 2.

FIG. 6 is an end view of a cross section along VI-VI in FIG. 2.

FIG. 7 is a plan view of a seat rotating device having a restraining portion in a first modification of the present embodiment.

FIG. 8 is an end view of a cross section along VIII-VIII in FIG. 7.

FIG. 9 is an end view of a cross section along IX-IX in FIG. 7.

### DESCRIPTION OF THE PREFERRED EMBODIMENTS

Hereinafter, an embodiment of the present disclosure will be described in detail with reference to the drawings. In the drawings, the same or corresponding parts will be designated by the same reference numerals, and the description thereof will not be repeated.

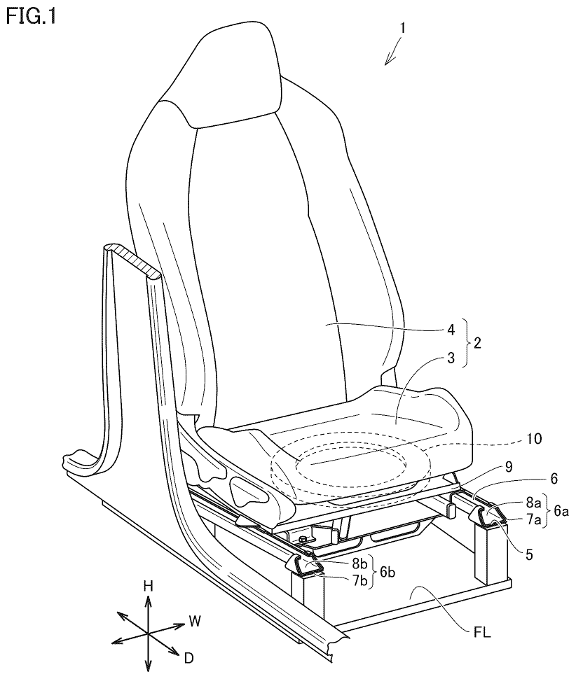

FIG. 1 is a schematic view of a rotary seat according to the present embodiment. An up-down direction H in FIG. 1 is, for example, an up-down direction of a vehicle provided with a rotary seat 1. A width direction W in FIG. 1 is a width direction of the vehicle. A front-rear direction D in FIG. 1 is a front-rear direction of the vehicle. It should be noted that up-down direction H is an example of the “first direction” in the present disclosure.

Rotary seat 1 includes a seat main body 2 and a seat rotating device 10. Seat main body 2 has a seat cushion 3 and a seat back 4. Seat cushion 3 supports the hip of an occupant. Seat back 4 supports the back of the occupant seated on seat cushion 3. Seat main body 2 is disposed on a floor FL of the vehicle.

It should be noted that seat rotating device 10 is an example of the “seat member movable device” in the present disclosure. Seat main body 2 is an example of the “seat member” in the present disclosure.

Rotary seat 1 is supported by a support mechanism 5.

More specifically, support mechanism 5 has a pair of sliders 6 and a base plate 9. The pair of sliders 6 are provided on floor FL. The pair of sliders 6 have a slider 6a and a slider 6b. Slider 6a and slider 6b are arranged with a spacing therebetween in width direction W. Slider 6a has a lower rail 7a and an upper rail 8a. Slider 6b has a lower rail 7b and an upper rail 8b. Lower rails 7a and 7b are fixed to floor FL in a posture parallel to front-rear direction D. Upper rail 8a is formed above lower rail 7a so as to be relatively displaceable with respect to lower rail 7a in front-rear direction D. The same applies to upper rail 8b. Upper rail 8a and upper rail 8b support base plate 9.

Base plate 9 is formed to connect upper rail 8a and upper rail 8b. Base plate 9 supports seat rotating device 10.

With such a configuration, seat main body 2 is movable in front-rear direction D, and is rotatable with respect to base plate 9 by seat rotating device 10. It should be noted that base plate 9 is an example of the “placement base” in the present disclosure.

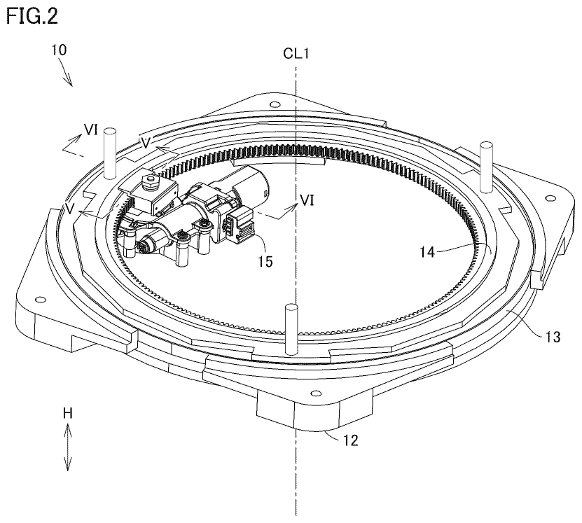

FIG. 2 is a perspective view of the seat rotating device. Seat rotating device 10 includes a bracket 11 (not shown), a base 12, a collar 13, a rotary disc 14, and a drive device 15.

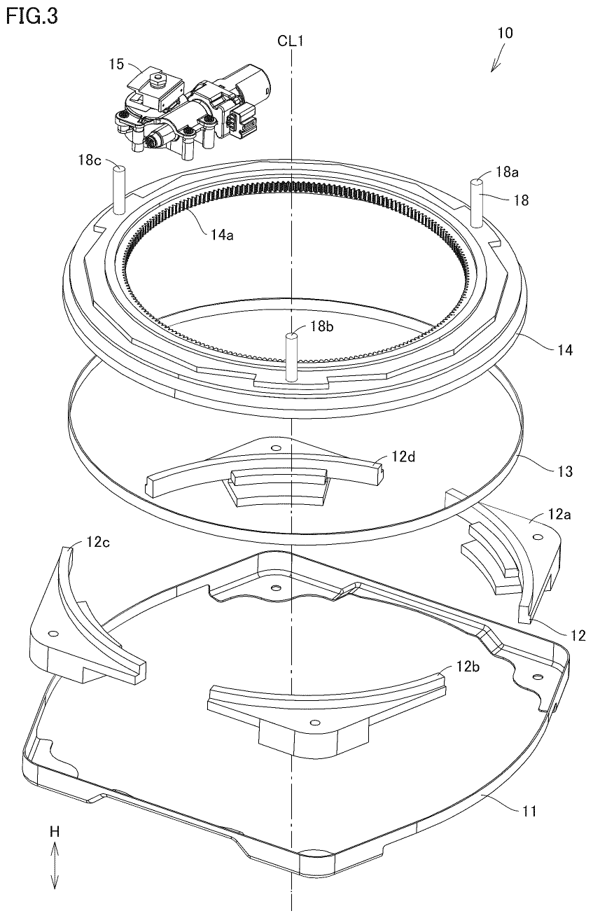

FIG. 3 is an exploded perspective view of the seat rotating device. It should be noted that rotary disc 14 is an example of the “support disc” in the present disclosure.

Bracket 11, base 12, collar 13, and rotary disc 14 are disposed coaxially with a rotation axis CL1. It should be noted that rotation axis CL1 is an axis located at the center of rotary disc 14 and extending in up-down direction H.

Base 12 is supported by bracket 11 in up-down direction H, and is fixed to base plate 9 shown in FIG. 1. Base 12 is constituted by four base portions 12a, 12b, 12c, and 12d. Base portions 12a, 12b, 12c, and 12d are arranged on a circle centered on rotation axis CL1, with a spacing of 90 degrees.

Rotary disc 14 is supported to be rotatable in a direction orthogonal to up-down direction H, with respect to base 12. Rotary disc 14 is formed to extend in an annular shape. An inner diameter of rotary disc 14 is larger than a width of the rotary disc, which is a difference between an outer diameter and the inner diameter of rotary disc 14. Rotary disc 14 is an internal gear having teeth 14a formed on an inner circumferential surface thereof. Rotary disc 14 has a seat main body fixing pin 18 formed to extend upward for supporting seat main body 2 (see FIG. 1). Seat main body fixing pin 18 is formed of pins 18a, 18b, and 18c. Pins 18a, 18b, and 18c are arranged on an imaginary circle centered on rotation axis CL1, with a spacing of 120 degrees. Collar 13 is provided around an outer circumference of rotary disc 14. Collar 13 is a plate-shaped member formed to extend in an annular shape.

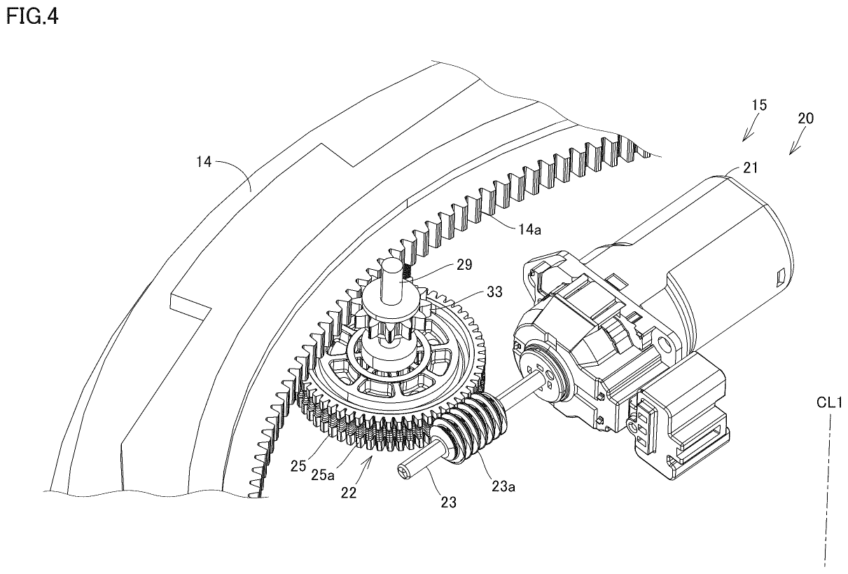

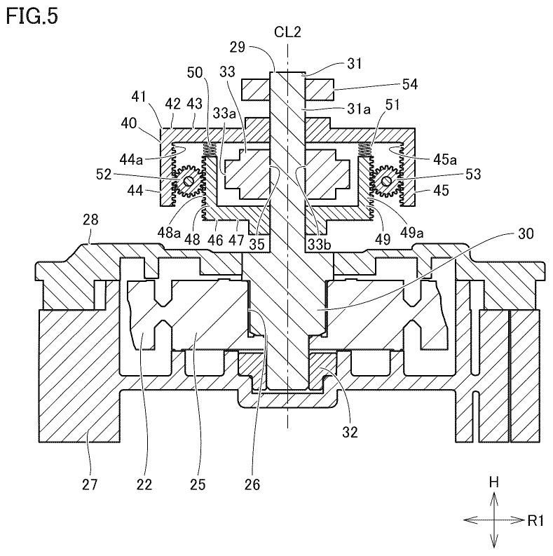

Next, drive device 15 will be described with reference to FIGS. 4, 5, and 6. Drive device 15 has a drive unit 20 shown in FIG. 4, and a housing 27, a cover 28, a bush 32, and a restraining unit 40 shown in FIG. 5.

Firstly, FIG. 4 is an enlarged perspective view of the drive device. It should be noted that illustration of housing 27, cover 28, bush 32, and restraining unit 40 is omitted in FIG. 4.

Referring to FIG. 4, drive device 15 is located inside rotary disc 14 formed in an annular shape. Drive unit 20 has a motor 21, a worm gear 22, a lifting/lowering shaft 29, and a pinion 33. Drive unit 20 is fixed to base plate 9 (not shown).

Motor 21 is supported by base plate 9 (not shown).

Worm gear 22 is connected to motor 21. Worm gear 22 has a worm 23 and a worm wheel 25.

Worm 23 is formed to extend in a direction orthogonal to rotation axis CL1. Teeth 23a are formed on worm 23. Worm 23 is formed to be rotatable in a rotational direction orthogonal to rotation axis CL1, by driving of motor 21.

On worm wheel 25, teeth 25a corresponding to teeth 23a of worm 23 are formed.

Secondly, FIG. 5 is an end view of a cross section along V-V in FIG. 2. It should be noted that a radial direction R1 in FIG. 5 is a radial direction of a rotation axis CL2 located at the center of worm wheel 25, and is a direction parallel to a tangent to rotary disc 14 at a point where pinion 33 (see FIG. 4) contacts the inner circumferential surface of rotary disc 14.

Referring to FIG. 5, worm wheel 25 is formed to be rotatable in the same direction as that of rotary disc 14 by a rotational movement of worm 23 (see FIG. 4). When worm wheel 25 is seen in a plan view from a position away from worm wheel 25 in up-down direction H, an insertion hole 26 is formed at the center of worm wheel 25.

Housing 27 and cover 28 are formed to cover worm gear 22. Housing 27 is fixed to base plate 9 (not shown).

Lifting/lowering shaft 29 is formed to extend in up-down direction H, and is formed in a columnar shape. Lifting/lowering shaft 29 is inserted into insertion hole 26 of worm wheel 25. Lifting/lowering shaft 29 is disposed coaxially with rotation axis CL2 of worm wheel 25, and is formed to be rotatable in a direction of rotation axis CL2 in synchronization with rotation of worm wheel 25. Lifting/lowering shaft 29 has a basis portion 30 and a support portion 31.

Basis portion 30 is inserted into insertion hole 26 of worm wheel 25. One end of basis portion 30 is supported by bush 32 supported by housing 27. Further, the other end of basis portion 30 is supported by cover 28 in the radial direction of rotation axis CL2.

Support portion 31 is formed to extend in up-down direction H. One end of support portion 31 is connected to an end portion of basis portion 30. A spiral groove 31a is formed in an outer circumferential surface of support portion 31.

Teeth 33a corresponding to teeth 14a (see FIG. 3) of rotary disc 14 are formed on an outer circumferential surface of pinion 33. An insertion hole 35 is formed at the center of pinion 33. A guide 33b corresponding to groove 31a of support portion 31 is formed on an inner circumferential surface defining insertion hole 35. Support portion 31 of lifting/lowering shaft 29 is inserted into insertion hole 35.

Restraining unit 40 has a movable portion 41 and a restraining portion 60 (not shown).

Movable portion 41 has a first plate-shaped member 42, a second plate-shaped member 46, springs 50 and 51, interlocking gears 52 and 53, and a stopper 54.

First plate-shaped member 42 and second plate-shaped member 46 are arranged in up-down direction H with pinion 33 being sandwiched therebetween. It should be noted that first plate-shaped member 42 is located above second plate-shaped member 46 in up-down direction H.

First plate-shaped member 42 has a first plate portion 43 and a pair of first side plate portions 44 and 45.

First plate portion 43 is formed to extend in radial direction R1.

The pair of first side plate portions 44 and 45 are formed to extend in up-down direction H. The pair of first side plate portions 44 and 45 are formed to hang down in up-down direction H from end surfaces of first plate portion 43 arranged in radial direction R1. Thereby, the pair of first side plate portions 44 and 45 are arranged in radial direction R1. In the pair of first side plate portions 44 and 45, teeth 44a and 45a are respectively formed on side surfaces facing lifting/lowering shaft 29, among side surfaces arranged in radial direction R1.

Second plate-shaped member 46 has a second plate portion 47 and a pair of second side plate portions 48 and 49.

Second plate portion 47 is formed to extend in radial direction R1. A length of second plate portion 47 in radial direction R1 is shorter than a length of first plate portion 43 in radial direction R1.

The pair of second side plate portions 48 and 49 are formed to extend in up-down direction H. The pair of second side plate portions 48 and 49 are formed to rise in up-down direction H from end surfaces of second plate portion 47 arranged in radial direction R1. Thereby, the pair of second side plate portions 48 and 49 are arranged in radial direction R1. In the pair of second side plate portions 48 and 49, teeth 48a and 49a are respectively formed on side surfaces facing opposite to lifting/lowering shaft 29, among side surfaces arranged in radial direction R1. The pair of second side plate portions 48 and 49 are disposed between first side plate portion 44 and first side plate portion 45.

Spring 50 connects first plate portion 43 and second side plate portion 48 in up-down direction H. Further, spring 51 similarly connects first plate portion 43 and second side plate portion 49 in up-down direction H.

Interlocking gear 52 is located between first side plate portion 44 and second side plate portion 48. Interlocking gear 52 is formed to correspond to teeth 44a and teeth 48a. Thereby, interlocking gear 52 connects the first plate-shaped member and the second plate-shaped member.

Interlocking gear 53 is located between first side plate portion 45 and second side plate portion 49. Interlocking gear 53 is formed to correspond to teeth 45a and teeth 49a.

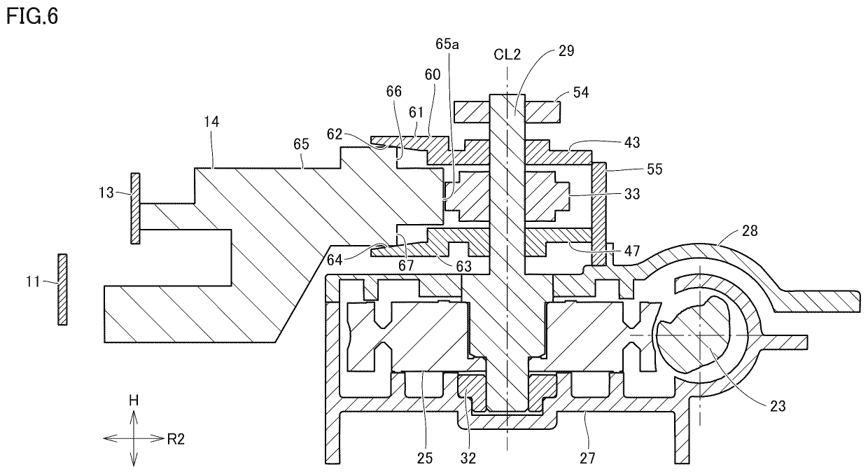

Thirdly, FIG. 6 is an end view of a cross section along VI-VI in FIG. 2. A radial direction R2 in FIG. 6 is the radial direction of rotation axis CL2 located at the center of worm wheel 25, and is the same direction as a direction of a straight line passing through rotation axis CL1 (see FIG. 4) and rotation axis CL2. Radial direction R2 is an example of the “second direction” in the present disclosure.

Referring to FIG. 6, interlocking gear 52 (see FIG. 5) and interlocking gear 53 (see FIG. 5) are each supported by a fixing plate 55 in up-down direction H. Fixing plate 55 is fixed to cover 28.

Stopper 54 is disposed at an end portion of lifting/lowering shaft 29 that is the other end with respect to bush 32.

Restraining portion 60 has a first gripping portion 61 and a second gripping portion 63.

First gripping portion 61 has one end formed to be connected to first plate portion 43, and the other end formed to extend toward rotary disc 14 in radial direction R2. First gripping portion 61 is disposed to cover an inner circumferential edge portion 65a of rotary disc 14 and the vicinity thereof from above in up-down direction H. First gripping portion 61 has a first restraining surface 62.

First restraining surface 62 is disposed at a position facing rotary disc 14, among surfaces of first gripping portion 61 arranged in up-down direction H. First restraining surface 62 is formed to be away from rotary disc 14 in up-down direction H, along a direction from first plate portion 43 toward rotary disc 14 in radial direction R2.

Second gripping portion 63 has one end formed to be connected to second plate portion 47, and the other end formed to extend toward rotary disc 14 in radial direction R2. Second gripping portion 63 is disposed to cover inner circumferential edge portion 65a of rotary disc 14 and the vicinity thereof from below in up-down direction H. Second gripping portion 63 has a second restraining surface 64.

Second restraining surface 64 is disposed at a position facing rotary disc 14, among surfaces of second gripping portion 63 arranged in up-down direction H. Second restraining surface 64 is formed to be away from rotary disc 14 in up-down direction H, along a direction from second plate portion 47 toward rotary disc 14 in radial direction R2.

Rotary disc 14 has a main body portion 65, a first contact portion 66, and a second contact portion 67. First contact portion 66 and second contact portion 67 are arranged in up-down direction H, and are provided on main body portion 65. First contact portion 66 protrudes upward in up-down direction H, with respect to inner circumferential edge portion 65a of main body portion 65 and the vicinity thereof. Second contact portion 67 protrudes downward in up-down direction H, with respect to inner circumferential edge portion 65a of main body portion 65 and the vicinity thereof. Thereby, first restraining surface 62 is formed to cover a part of first contact portion 66. Further, second restraining surface 64 is formed to cover a part of second contact portion 67.

Seat rotating device 10 in the embodiment described above has restraining unit 40. Restraining unit 40 has first plate-shaped member 42 and second plate-shaped member 46 arranged in the up-down direction. Springs 50 and 51 connect first plate portion 43 of first plate-shaped member 42 and second plate portion 47 of second plate-shaped member 46, and apply such a force that brings first plate-shaped member 42 closer to second plate-shaped member 46. In addition, first gripping portion 61 and second gripping portion 63 are provided to first plate portion 43 and second plate portion 47, respectively.

With such a configuration, first gripping portion 61 and second gripping portion 63 forming restraining portion 60 sandwich rotary disc 14 therebetween in up-down direction H, and thereby, rotation of rotary disc 14 can be restrained. Further, rattling of rotary disc 14 in up-down direction H or a radial direction of rotation about rotation axis CL1 can be suppressed. It should be noted that a state in which the rotation of rotary disc 14 is restrained is referred to as a restrained state.

In the embodiment described above, rotary disc 14 has first contact portion 66 and second contact portion 67 that protrude from main body portion 65 in up-down direction H. Further, first gripping portion 61 and second gripping portion 63 have first restraining surface 62 and second restraining surface 64, respectively. First restraining surface 62 and second restraining surface 64 are angled with respect to a plane in which rotary disc 14 rotates.

With such a configuration, in the restrained state, first restraining surface 62 contacts first contact portion 66 at a point or a line. The same applies to the relation between second restraining surface 64 and second contact portion 67. Thereby, tolerance of the shape of rotary disc 14 can be moderated.

In the embodiment described above, guide 33b corresponding to groove 31a formed in the outer circumferential surface of support portion 31 of lifting/lowering shaft 29 is formed on the inner circumferential surface of insertion hole 35 of pinion 33. Interlocking gears 52 and 53 are formed to transmit movement of at least one of first plate-shaped member 42 and second plate-shaped member 46 away from or closer to the other thereof in up-down direction H, to the other thereof.

With such a configuration, since rotary disc 14 does not move in the restrained state, pinion 33 moves in up-down direction H in conjunction with rotation of lifting/lowering shaft 29. When pinion 33 moves upward in up-down direction H, for example, pinion 33 moves first plate-shaped member 42 in a direction away from second plate-shaped member 46. Movement of first plate-shaped member 42 away from second plate-shaped member 46 is also transmitted to second plate-shaped member 46 by interlocking gears 52 and 53, and the restrained state of rotary disc 14 is released. After release, pinion 33 starts a rotational movement about rotation axis CL2, and rotary disc 14 is rotated by pinion 33. In this manner, one motor 21 included in seat rotating device 10 can switch rotary disc 14 between the restrained state and an unrestrained state, and rotate rotary disc 14. Thereby, it is possible to provide a seat member movable device having a smaller number of components and a lighter weight than a conventional seat rotating device.

In the present disclosure, drive device 15 is located inside rotary disc 14.

With such a configuration, a height of seat rotating device 10 in up-down direction H can be reduced.

Although the embodiment described above has exemplified rotary disc 14 in seat rotating device 10 as a representative example of the support disc in the present disclosure, the present disclosure is not limited thereto. For example, the support disc may be a power lifter mechanism in a seat height adjustment device, or a power tilt mechanism in a tilt adjustment device. Further, the support disc may be a pinion gear formed on a straight line.

Although the embodiment described above has exemplified up-down direction H as a representative example of the first direction in the present disclosure, the present disclosure is not limited thereto. For example, the first direction may be defined as a direction orthogonal to a moving direction of the support disc.

Although the embodiment described above has exemplified radial direction R2 as a representative example of the second direction in the present disclosure, the present disclosure is not limited thereto. For example, the second direction may be defined as a direction orthogonal to the moving direction of the support disc and the first direction.

Although the embodiment described above has described an example in which the inner diameter of rotary disc 14 is larger than the width of the rotary disc, which is the difference between the outer diameter and the inner diameter of rotary disc 14, the present disclosure is not limited thereto. For example, the inner diameter of rotary disc 14 may be smaller than the width of the rotary disc, which is the difference between the outer diameter and the inner diameter of rotary disc 14. Thereby, the outer diameter of rotary disc 14 can be reduced, and manufacturability of rotary disc 14 is improved. Further, an increase in the size of seat rotating device 10 can be suppressed.

### First Modification

Although the embodiment described above has described an example in which restraining portion 60 sandwiches rotary disc 14 in up-down direction H and thereby restrains the rotation of rotary disc 14, the present disclosure is not limited thereto. For example, drive device 15 may have a restraining portion 70 instead of restraining portion 60.

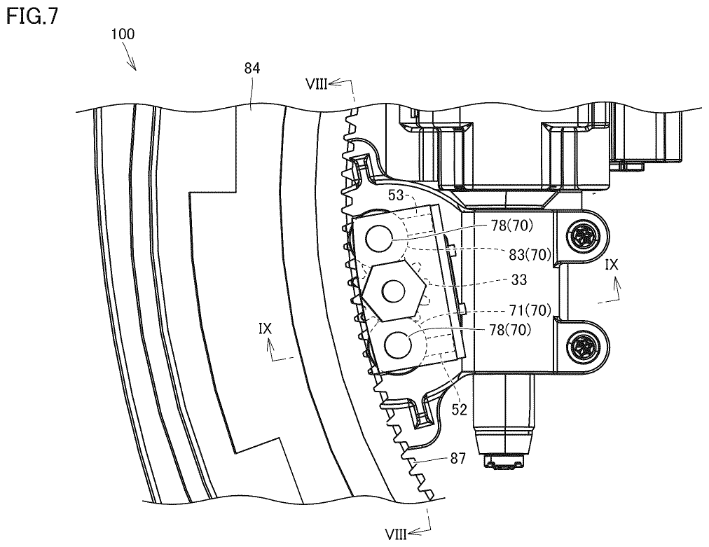

FIG. 7 is a plan view of a seat rotating device 100 having restraining portion 70 in a first modification of the present embodiment, as seen in a plan view from a position away therefrom in up-down direction H. Seat rotating device 100 and restraining portion 70 thereof have the same configurations as those of seat rotating device 10 and restraining portion 60 thereof in the embodiment of the present disclosure, respectively, unless otherwise described below.

Restraining portion 70 has a restraining gear 71, a restraining gear 83, and shafts 78. Restraining gear 71 and restraining gear 83 are disposed between first plate-shaped member 42 and second plate-shaped member 46. Restraining gear 71 and restraining gear 83 are arranged along a circumferential direction of an inner circumference of a rotary disc 84. Pinion 33 is disposed between restraining gear 71 and restraining gear 83.

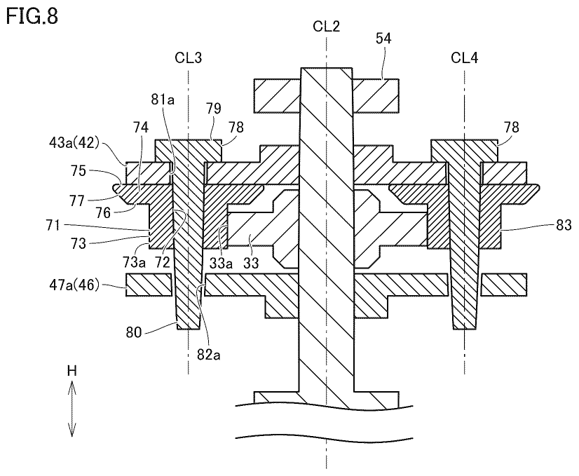

FIG. 8 is an end view of a cross section along VIII-VIII in FIG. 7. It should be noted that cover 28 is omitted in FIG. 8.

Restraining gear 71 is formed to be rotatable about a rotation axis CL3. Restraining gear 83 is formed to be rotatable about a rotation axis CL4. Further, restraining gear 71 and restraining gear 83 rotate in conjunction with rotation of pinion 33. It should be noted that restraining gear 71 and restraining gear 83 rotate in a direction opposite to a rotational direction of pinion 33. Restraining gear 71 and restraining gear 83 have substantially the same configuration. An insertion hole 72 is formed in restraining gear 71. Insertion hole 72 is formed to extend in up-down direction H. Restraining gear 71 has a gear portion 73 and an abutting portion 74. Abutting portion 74 is connected to one end of gear portion 73 in up-down direction H.

Gear portion 73 is formed in the shape of a column formed to extend in up-down direction H. Gear portion 73 is located below abutting portion 74 in up-down direction H. Teeth 73a are formed on an outer circumferential surface of gear portion 73. Teeth 73a are formed in a shape corresponding to teeth 33a of pinion 33.

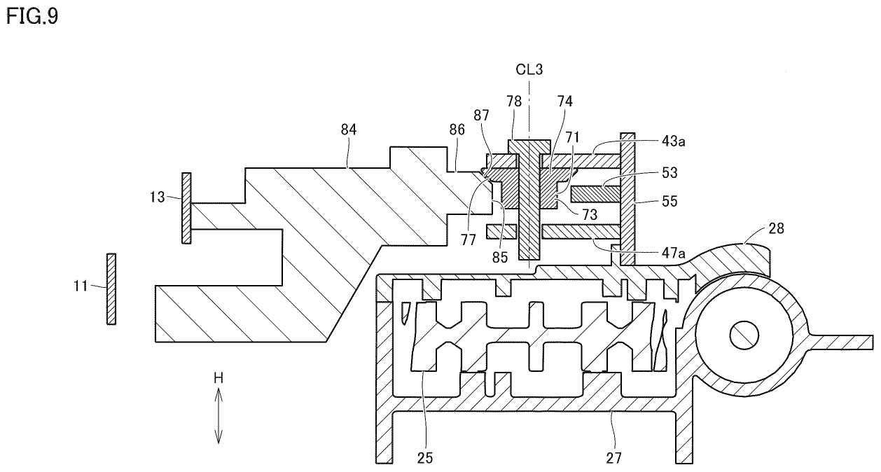

Abutting portion 74 is formed in a disc shape. A diameter of abutting portion 74 is larger than a diameter of gear portion 73. Abutting portion 74 has a contact surface 75, a pressing surface 76, and an abutting surface 77. Contact surface 75 and pressing surface 76 are arranged in up-down direction H. It should be noted that pressing surface 76 is located below contact surface 75. Abutting surface 77 connects an outer circumferential edge portion of contact surface 75 and an outer circumferential edge portion of pressing surface 76. Abutting surface 77 is formed to expand outward from the center of gear portion 73, along a direction from pressing surface 76 toward contact surface 75. Abutting surface 77 is disposed at a position facing a chamfer surface 87 described later (see FIG. 9).

Shaft 78 is formed to extend in up-down direction H. Shaft 78 has a head portion 79 and a shaft portion 80. Head portion 79 is provided at one end of shaft portion 80. Shaft portion 80 is formed to extend downward from head portion 79 in up-down direction H. A through hole 81a and a through hole 82a formed to extend in up-down direction H are formed in a first plate portion 43a and a second plate portion 47a. Shaft portion 80 penetrates through hole 81a and through hole 82a, and is inserted into insertion hole 72. Shaft 78 is formed such that restraining gear 71 is rotatable.

FIG. 9 is an end view of a cross section along IX-IX in FIG. 7.

Rotary disc 84 has chamfer surface 87 connecting an inner circumferential surface 85 and an upper surface 86. Chamfer surface 87 is formed to have the same inclination as that of abutting surface 77.

In the first modification of the embodiment described above, restraining gear 71, pinion 33, and restraining gear 83 are arranged in this order along the circumferential direction of the inner circumference of rotary disc 84. Restraining gear 71 and restraining gear 83 each have abutting surface 77. Rotary disc 84 has chamfer surface 87, which is a surface parallel to abutting surface 77, at a position facing abutting surface 77. Springs 50 and 51 apply, to first plate portion 43a and second plate portion 47a, such a force that brings first plate portion 43a closer to second plate portion 47a.

With such a configuration, abutting surface 77 of each of restraining gear 71 and restraining gear 83 abuts against chamfer surface 87 by the force of springs 50 and 51 that brings first plate portion 43a closer to second plate portion 47a. When lifting/lowering shaft 29 performs a rotational movement in this state, lifting/lowering shaft 29 applies a force in the same rotational direction as a rotational direction of lifting/lowering shaft 29 to pinion 33. Pinion 33 applies a force in the same rotational direction as the rotational direction of pinion 33 to rotary disc 84, and applies a force in a rotational direction opposite to the rotational direction of pinion 33 to restraining gear 71 and restraining gear 83 engaged with pinion 33. Restraining gear 71 and restraining gear 83 each apply a force in the rotational direction opposite to the rotational direction of pinion 33 to rotary disc 84 via abutting surface 77.

As described above, since the force in the same rotational direction as the rotational direction of pinion 33 is applied from pinion 33 to rotary disc 84, and the force in the rotational direction opposite to the rotational direction of pinion 33 is applied from restraining gear 71 and restraining gear 83 to rotary disc 84, the forces applied to rotary disc 84 to rotate rotary disc 84 can be offset. That is, a rotational movement of rotary disc 84 can be restrained. A state in which the rotational movement of rotary disc 84 is restrained is referred to as a restrained state.

When lifting/lowering shaft 29 starts a rotational movement in the restrained state, pinion 33 cannot perform a rotational movement and thus moves in up-down direction H along groove 31a of lifting/lowering shaft 29. When pinion 33 moves upward in up-down direction H, pinion 33 contacts pressing surface 76 of each of restraining gear 71 and restraining gear 83, and moves first plate portion 43a upward together with restraining gear 71 and restraining gear 83. Alternatively, when pinion 33 moves downward in up-down direction H, pinion 33 contacts second plate portion 47a, and movement of second plate portion 47a in a direction away from first plate portion 43a is transmitted to first plate portion 43a by interlocking gears 52 and 53. As first plate portion 43a moves, restraining gear 71 and restraining gear 83 move away from each other. Thereby, abutting surface 77 is brought out of contact with chamfer surface 87, and the restrained state is released.

In this manner, one motor 21 included in seat rotating device 100 can switch rotary disc 84 between the restrained state and an unrestrained state, and rotate rotary disc 84. Thereby, it is possible to provide a seat member movable device having a smaller number of components and a lighter weight than a conventional seat member movable device.

Although the embodiment of the present invention has been described, it should be understood that the embodiment disclosed herein is illustrative and non-restrictive in every respect. The scope of the present invention is defined by the scope of the claims, and is intended to include any modifications within the scope and meaning equivalent to the scope of the claims.

What is claimed is:

1. A seat member movable device that moves a seat member with respect to a placement base, the member movable device comprising:
a support disc that supports the seat member; and
a drive device that moves the support disc, wherein
the drive device includes a drive unit and a restraining unit,
the drive unit has a motor, a pinion formed to move the support disc, and a lifting/lowering shaft,
the lifting/lowering shaft is formed to extend in a first direction, and is formed to be rotatable by driving of the motor,
the lifting/lowering shaft has a support portion in which a spiral groove is formed,
an insertion hole into which the lifting/lowering shaft is inserted is formed at a center of the pinion,
on an inner circumferential surface defining the insertion hole, a guide corresponding to the spiral groove formed in the support portion is formed,
the restraining unit has a movable portion and a restraining portion,
the movable portion has a first plate-shaped member, a second plate-shaped member, a spring, and an interlocking gear,
the first plate-shaped member and the second plate-shaped member are arranged in the first direction with the pinion being sandwiched therebetween,
the spring connects the first plate-shaped member and the second plate-shaped member, and applies a force that brings the first plate-shaped member closer to the second plate-shaped member, to the first plate-shaped member and the second plate-shaped member,
the interlocking gear connects the first plate-shaped member and the second plate-shaped member, and is formed to transmit movement of one of the first plate-shaped member and the second plate-shaped member closer to or away from another thereof, to the other thereof,
the restraining portion is formed to restrain movement of the support disc, and
in a restrained state in which the movement of the support disc is restrained by the restraining unit, as the lifting/lowering shaft is rotated by the driving of the motor, the pinion moves in the first direction, and moves the one of the first plate-shaped member and the second plate-shaped member in a direction away from the other thereof, to release the restrained state by the restraining unit.

2. The seat member movable device according to claim 1, wherein
the first plate-shaped member has a first plate portion,
the second plate-shaped member has a second plate portion,
the restraining portion has a first gripping portion and a second gripping portion,
the first gripping portion has one end formed to be connected to the first plate portion, and another end formed to extend toward the support disc in a second direction intersecting the first direction,
the second gripping portion has one end formed to be connected to the second plate portion, and another end formed to extend toward the support disc in the second direction, and
in the restrained state, the first gripping portion and the second gripping portion sandwich the support disc therebetween.

3. The seat member movable device according to claim 2, wherein
the support disc has a main body portion, a first contact portion, and a second contact portion,
the first contact portion and the second contact portion are arranged in the first direction, and are provided on the main body portion,
the first contact portion is formed to protrude in the first direction with respect to an inner circumferential edge portion of the main body portion and a vicinity thereof,
the first gripping portion has a first restraining surface disposed at a surface facing the first contact portion in the first direction,
the first restraining surface is formed to be away from the support disc in the first direction, along a direction from the first plate portion toward the first contact portion,
the second contact portion is formed to protrude in the first direction with respect to the inner circumferential edge portion of the main body portion and the vicinity thereof,
the second gripping portion has a second restraining surface disposed at a surface facing the second contact portion in the first direction, and
the second restraining surface is formed to be away from the support disc in the first direction, along a direction from the second plate portion toward the second contact portion.

4. The seat member movable device according to claim 1, wherein
a chamfer surface is formed on the support disc,
the restraining portion has a restraining gear,
the restraining gear is disposed between the first plate-shaped member and the second plate-shaped member, and is formed to be movable in the first direction as the first plate-shaped member moves,
the restraining gear has a gear portion and an abutting portion,
the gear portion is formed to extend in the first direction, and is formed to be rotatable in a direction opposite to a rotational direction of the pinion, in conjunction with the pinion,
the abutting portion is connected to one end of the gear portion in the first direction,
the abutting portion has an abutting surface facing the chamfer surface, and
in the restraining portion, in the restrained state, the abutting surface abuts against the chamfer surface.

5. The seat member movable device according to claim 1, wherein
the support disc is formed in an annular shape,
an inner diameter of the support disc is larger than a width of the support disc, which is a difference between an outer diameter and the inner diameter of the support disc, and
the drive device is located inside the support disc.

6. The seat member movable device according to claim 1, wherein
the support disc is formed in an annular shape, and
an inner diameter of the support disc is smaller than a width of the support disc, which is a difference between an outer diameter and the inner diameter of the support disc.
